(19) United States
(12) Patent Application Publication
(10) Pub. No.: US 2019/0145510 A1
(43) Pub. Date: May 16, 2019

(54) SHIFTER ASSEMBLY

(71) Applicant: Fico Triad, S.A, Barcelona (ES)

(72) Inventors: Javier MORENO COLOM, Barcelona (ES); Marçal COT PADRÓ, Barcelona (ES); Oscar FERRER RIBAS, Barcelona (ES)

(73) Assignee: Fico Triad, S.A, Barcelona (ES)

(21) Appl. No.: 16/189,627

(22) Filed: Nov. 13, 2018

(30) Foreign Application Priority Data
Nov. 13, 2017 (EP) 17382768.4

(51) Int. Cl. F16H 59/10; F16H 59/02

(52) U.S. Cl. CPC F16H 59/10; F16H 59/0278; F16H 59/0217

(57) ABSTRACT

The shifter assembly comprises a shifter lever that can be moved according to a first movement to perform shift operations involving changing gearshift positions for controlling a vehicle transmission in at least one mode of operation, and according to a second movement to perform select operations to change between at least two different modes of operation, and a sensing unit comprising a magnetic sensor to detect both rotational and displacement movements of at least one magnet to identify whether shift or select operations are being performed by the shifter lever. The magnet is arranged to perform a rotational movement relative to the magnetic sensor according to one of the first or second movements of the shifter lever, and to perform a displacement movement relative to the magnetic sensor according to the other of the movements of the shifter lever.

### CROSS-REFERENCE TO RELATED APPLICATIONS

This application claims priority to European patent application No. EP 17382768.4 filed on Nov. 13, 2017, the disclosure of which is incorporated in its entirety by reference herein.

### TECHNICAL FIELD

The present disclosure relates to shifter assemblies for controlling a vehicle transmission, and more particularly to shifter assemblies of the shift-by-wire or automatic type in which the shifter lever can be actuated according to different movements to perform different operations for controlling a vehicle transmission in different modes of operation.

### BACKGROUND

Shifter assemblies adapted to allow selection of different modes of operation of the vehicle transmission are known in the art. The shifter assemblies include a shifter lever for controlling a vehicle transmission according to the different modes of operation of the transmission and also for selecting between the different modes of operation. A first mode of operation may be, for example, a manual mode for controlling the transmission in which gear positions are manually changed by a driver. A second mode of operation may be an automatic mode for controlling the transmission in which gear positions are changed automatically according to vehicle speed when a driver selects a drive mode.

Shifter assemblies include means for detecting the position of the shifter lever are also known in the art which may be provided in the shifter assembly. The shifter lever position detecting means usually comprise hall sensors and magnets arranged to detect a gear position that has been selected by the user. In this way, a particular position of the shifter lever can be identified using an electrical signal that is detected by the hall sensors.

Attempts have been made to also provide the shifter lever position detecting means in the above mentioned shifter assemblies with different modes of operation in which the shifter lever moves in different paths. For example, US2004035237 provides a shifting device in which the shifter lever can be moved at least along a first axis and a second axis to select shift positions and means for detecting the position of the shift lever. The detecting means comprises a magnet that can be moved in a vertical direction by the shifter lever and a magnetic sensor comprising hall sensors arranged along the vertical direction facing the magnet.

Such shifter assembly involves direct contact between a case containing the magnet and the shifter lever which result in friction and wear such that efficiency and accuracy may become adversely affected over time and with modes of shift positions possibly incorrectly selected in operation.

### SUMMARY

A solution to the above problems is herein provided consisting of a shifter assembly for controlling a vehicle transmission with a detection system particularly intended for detection of the position of a shifter lever having two or more degrees of freedom such as for shifter levers running along manual and automatic rails.

Specifically, the present disclosure relates to a shifter assembly for controlling a vehicle transmission comprising a shifter lever and a single sensing unit.

The shifter lever in the present shifter assembly is pivotally mounted to a fixed base, such as a housing fixed to a vehicle body. The shifter lever can be moved relative to the housing according to at least a first movement and a second, different movement.

The sensing unit is arranged to detect both rotational and axial displacement movements of a magnet, so as to identify whether the above mentioned first or second movement is being performed by the shifter lever.

In one example, one or the first and second movements is to perform shift operations involving changing gearshift positions, such as for example Park (P), Reverse (R), Neutral (N) and Drive (D), or changing gears manually, for controlling a vehicle transmission in at least one mode of operation. The other of the first and second movements is to perform select operations to change between at least two different modes of operation.

The at least two different modes of operation may be, for example, a manual mode of operation for controlling the transmission in which gear positions are manually changed by a driver, and an automatic mode of operation for controlling the transmission in which gear positions are changed automatically according to vehicle speed when a driver selects a drive mode.

The first movement of the shifter lever may, for example, be performed substantially in a first plane and the second movement of the shifter lever may be performed substantially in a second, different plane. Other types of movement of the shifter lever are of course not ruled out.

The sensing unit in the present shifter assembly comprises a magnet and at least one magnetic sensor. The magnetic sensor is arranged to detect both rotational and displacement movements of the magnet.

Detection of both rotational and displacement movements of the magnet by the magnetic sensor is used to identify whether shift or select operations are being performed by the shifter lever, that is, to identify whether the shifter lever is being actuated by the user to either perform a first movement or a second movement for changing gearshift positions or for changing between the different modes of operation, respectively.

In the most preferred example of the present shifter assembly, the sensing unit comprises only a single magnetic sensor. Such a single magnetic sensor is adapted to detect both rotational and displacement movements of the magnet as described above to identify whether shift or select operations are being performed by the shifter lever. A sensor could be provided for sensing rotational movement of the magnet and a sensor for sensing displacement movement thereof. A very simple and cost effective assembly is thus advantageously obtained.

In a further example of the present shifter assembly, the magnet may be a diametrically polarized magnet. However, other types of suitable magnets can be used. A support member is provided for carrying the magnet. The support member is arranged to be driven in rotation as the shifter lever is actuated according to a given movement as it will be described. The magnet may be provided at one end portion of such support member, with one surface of the magnet facing the magnetic sensor having at least a first pole and a second pole.

In use, the magnet is arranged to perform the above described different movements. Specifically, the magnet is arranged to perform a rotational movement relative to the magnetic sensor according to one of the first or second movements of the shifter lever. The magnet is arranged also to perform an axial displacement movement relative to the magnetic sensor according to the other of the first or second movements of the shifter lever. The displacement movement of the magnet relative to the magnetic sensor may be performed along a longitudinal axis thereof. This may be referred to as a change in an airgap between the magnetic sensor and the magnet.

An axial displacement movement relative to the magnetic sensor is defined herein with respect to the longitudinal axis of the sensor unit.

According to the above configuration, the different movements of the shifter lever can be detected by the same single magnetic sensor and only one magnet, as opposed to known shifter assemblies in which different magnetic sensors and magnets are required for detecting different movements of the shifter lever. Complexity, operating space and costs are advantageously reduced with the present shifter assembly. In addition, with the above configuration of the present shifter assembly reliability of shifter lever path detection is highly improved and clearance between the magnet and the magnetic sensor may be reduced.

The rotational movement of the magnet may be caused by the first movement the shifter lever, for example, a rotational movement thereof, in a way that a rotation angle of the magnet is the same or, preferably, higher than a rotation angle of the shifter lever. In one example, a ratio of a rotation angle of the magnet to a rotation angle of the shifter lever may range from 2 to 5. Other ratios are also possible.

In order to cause rotational movement of the magnet by the first movement of the shifter lever, e.g., a corresponding rotational movement of the shifter lever, a driving member may be provided between them. The driving member is configured to impart a rotational movement on the support member, and thus the magnet, as the shifter lever is actuated according to the above ratio, that is, with the rotation angle of the support member or the magnet being 2 to 5 times that of the shifter lever. Rotational movement on the support member, and thus the magnet, is thus performed as the shifter lever is operated by the user to perform shift operations, i.e., operations involving changing gearshift positions, such as for example Park (P), Reverse (R), Neutral (N) and Drive (D), or changing gears manually, for controlling a vehicle transmission. The driving member may be attached or be part of a shift shaft arranged to be driven in rotation as the shifter lever is actuated according to the first movement to perform the shift operations. The shift shaft may be attached to or be part of the shifter lever.

It may be preferred that a rotational displacement of the magnet between the gearshift positions, for example, between two consecutive gearshift positions P, R, N, D, ranges from 7 to 12°. Other rotational displacements are of course possible.

A driving plate may be provided for causing an axial linear displacement of the support member as the shifter lever is actuated for changing a mode of operation. The driving plate may be integral with the shifter lever. The driving plate may be a separate part from the shifter lever in which case the driving plate would act as a multiplier causing the amount of axial movement of the shifter lever to be different to that of the support member as it is rotated.

In one preferred example of the present shifter assembly, the magnetic sensor is arranged on a printed circuit board that is operative to detect the movements of the magnet relative to the magnetic sensor, and particularly both rotational and axial displacement movements of the magnet as stated above.

The sensing unit or a circuitry arranged in the PCB is configured to generate corresponding electrical signals from detected movements of the magnet so as to control a vehicle transmission. It may be preferred that the printed circuit board is positioned in a substantially vertical position such that a compact, space-saving design is achieved.

With the above described shifter assembly, a single magnetic sensor is used to detect both axial displacement and rotational movements, i.e., airgap and rotation angle, of the moving magnet. It is important to note that axial displacement and rotational movements of the magnet are detected independently of one another. With the present shifter assembly, there is no need for additional magnets to detect changes in the airgap between the magnet and the magnetic sensor and the rotational movement of the magnet during use.

An integrated assembly is thus achieved that is capable to perform a centralized continuous detection of axial displacement and rotational movements of the shifter lever through the use of a single sensor and a single magnet. A wide range of shifter lever detection can be obtained.

Additional objects, advantages and features of examples of the present shifter assembly will become apparent to those skilled in the art upon examination of the description, or may be learned by practice thereof.

### BRIEF DESCRIPTION OF THE DRAWINGS

Particular embodiments of the present shifter assembly will be described in the following by way of non-limiting examples, with reference to the appended drawings, in which:

FIG. 1 is a general perspective view of a first example of the present shifter assembly showing the shifter lever in different positions according to a first movement to perform shift operations;

FIG. 2 is a general perspective view of the first example of the shifter assembly in FIG. 1 showing the shifter lever in one position according to a second movement to perform select operations to change between at least two different modes of operation;

FIG. 3 is a general perspective view of a second example of the present shifter assembly showing the shifter lever in one position according to a first movement to perform shift operations; and

FIG. 4 is a general perspective view of the example of the shifter assembly in FIG. 3 showing the shifter lever in one position according to a second movement to perform select operations to change between at least two different modes of operation.

### DETAILED DESCRIPTION

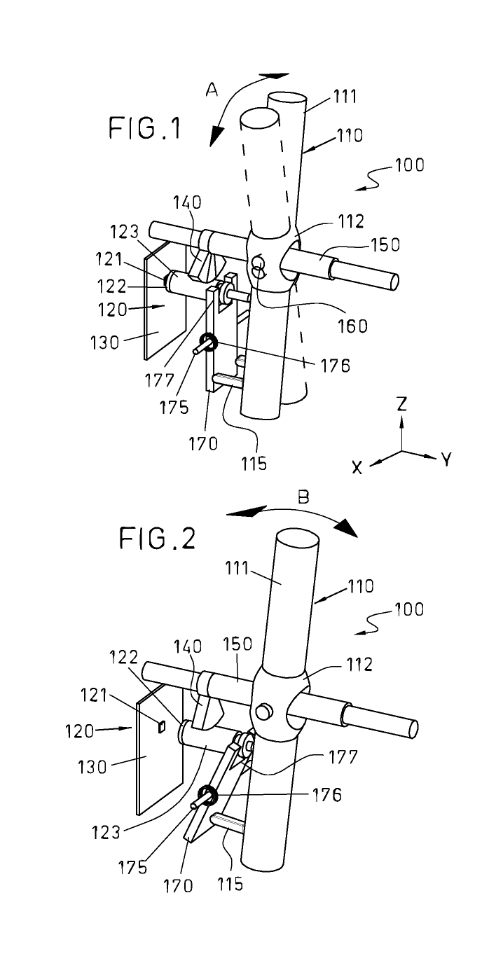

FIGS. 1-4 show two examples of the present shifter assembly 100. The shifter assembly 100 in FIGS. 1-4 is of the shift-by-wire or automatic type and is intended for controlling a vehicle transmission according to two different modes of operation as it will be described below.

The shifter assembly 100 comprises a shifter lever 110 that is pivotally mounted to a fixed base. The fixed base, not shown in the drawings, may be a housing fixed to a vehicle body suitable for receiving therein a lower end of the shifter lever 110.

The shifter lever 110 comprises a main shaft 111 having an upper end that is adapted to receive a knob, not shown in the drawings, and a lower end that is received inside the fixed base as stated above. The shifter lever 110 further comprises a partially spherical portion 112, as shown in the figures of the drawings, that is formed at one joint section of the main shaft 111. Other configurations are of course possible, such as for example cross joint, ball joint, combined ball-cross joint, etc. In the joint section of the main shaft 111 a shift shaft 150 and a select shaft 160 are attached to or formed integral with the shifter lever 110. The shift shaft 150 and the select shaft 160 are arranged at right angles to each other and coupled to a socket member, not shown, formed in the interior of the fixed base.

In this way, the shifter lever 110 can be moved in three-dimensional space according to two degrees of freedom, that is, the shifter lever 110 is allowed to be moved according to two different movements, defined by arrows A and B in the drawings, to perform different operations for controlling a vehicle transmission, as it will be described further below.

Specifically, the shifter lever 110 is capable of performing gear selection in two modes of operation in the example shown. In the both examples of the figures, the first mode of operation corresponds to a manual mode of operation for controlling the vehicle transmission in which gear positions are manually changed by a driver, and the second mode of operation is an automatic mode of operation for controlling the vehicle transmission automatically according to vehicle speed when a driver selects a drive mode.

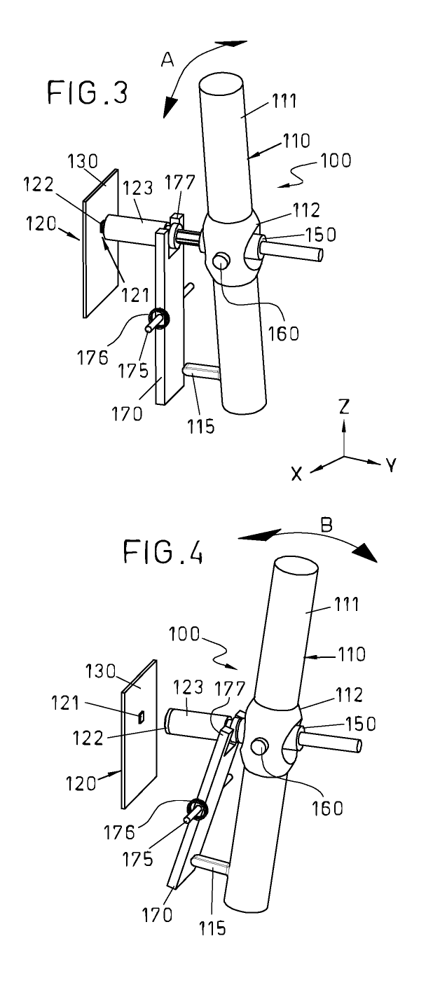

The above mentioned two different movements of the shifter lever 100, defined by arrows A and B in the drawings, relative to the housing are as follows. The shifter lever 100 can be actuated according to a first movement, defined by arrow A, to perform shift operations. The first movement of the shifter lever 100 is shown in FIGS. 1 and 3, and corresponds to the shifter lever 100 driven in a forward-to-backward movement in a substantially first plane XZ for changing gearshift positions, P, R, N, D in an automatic mode. The second movement of the shifter lever 100, defined by arrow B, is shown in FIGS. 2 and 4 of the drawings, and corresponds to the shifter lever 100 driven in a side-to-side movement, in a substantially second plane YZ for performing select operations, that is, for changing a mode of operation (manual or automatic in the example shown) between the above mentioned modes of operation.

As shown in the figures, the first plane XZ is defined by a longitudinal axis X of the select shaft 160 and a vertical axis Z. The second plane YZ is defined by a longitudinal axis Y of the shift shaft 150 and the vertical axis Z. The first and second planes XZ, YZ are therefore perpendicular to each other.

A sensing unit 120 is provided. The sensing unit 120 comprises a single magnetic sensor 121 and a magnet 122 arranged at one end portion of a support member 123 such that a front surface of the magnet 122 with at least a first pole and a second pole is arranged facing the magnetic sensor 121. The magnet 122 is in this example a diametrically polarized magnet although other types of magnets 122 can be of course used. The support member 123 can be over molded on the magnet 122.

The magnetic sensor 121 is arranged to detect a rotational movement of the magnet 122 around axis Y, that is, a rotational movement around the shift shaft 150 as the shifter lever 110 is actuated in a forward-to-backward movement, that is movement defined by arrow A, in the first plane XZ for changing gearshift positions. In this non-limiting example, a rotational displacement of the magnet 122 between two consecutive gearshift positions is from 2 to 10°.

The magnetic sensor 121 is also arranged to detect an axial displacement movement of the magnet 122 along an axis parallel to axis Y, that is, along an axis parallel to the shift shaft 150 as the shifter lever 110 that is actuated according to a side-to-side movement, that is movement defined by arrow B, in the second plane YZ for performing select operations, that is, for selecting a manual or an automatic mode of operation. The axial displacement of the magnet 122 relative to the magnetic sensor 121 defines a variation in an airgap between the magnetic sensor 121 and the magnet 122 as shown in the figures.

A driving plate 170 is provided for causing a linear axial displacement movement of the support member 123, that is, the magnet 122, along an axis parallel to axis Y, guided through the housing, as the shifter lever 110 is driven by the user according to the side-to-side movement, that is movement defined by arrow B, in the second plane YZ for selecting a manual or an automatic mode of operation. The axial displacement of the support member 123 with the magnet 122 could be guided through other parts associated with the housing, such as, for example, the shift shaft 150.

The driving plate 170 can be rotated around a pivot axis 175 against a torsion spring 176 as a lower end of the driving plate 170 is pushed by an actuator 115. However, the support member 123 could be provided to be displaced directly by the shifter lever 110 without using a driving plate 170. The actuator 115 is attached to the shifter lever 110 projecting outwards therefrom towards the driving plate 170. A receiving portion 177 is formed in an upper end of the driving plate 170. The receiving portion 177 has an opening defining a U-shaped portion for receiving a recess formed at one end of the support member 123 such that the support member 123 is coupled to the driving plate 170. Rotation of the driving plate 170 around pivot axis 175 causes an axial displacement of the support member 123 axially with respect to the magnetic sensor 121, parallel to the Y axis. Such U-shape in the receiving portion 177 allows the support member 123 to be displaced axially preventing it to be displaced along axis Z, since as the shifter lever 110 is rotated relative to the select shaft 160, the movement is not only linear.

The driving plate 170 thus acts as a multiplier causing the amount of axial movement of the shifter lever 110 to be different to that of the support member 123 as it is rotated according to arrow B according to the side-to-side movement thereof.

Specifically, as the shifter lever 110 is driven by the user to the right, that is clockwise movement defined by arrow B, in the second plane YZ for selecting a manual or an automatic mode of operation, the actuator 115 of the shifter lever 110 pushes the lower end of the driving plate 170 causing the driving plate 170 to be rotated in the same direction against spring 176. As a result, the support member 123 together with the magnet 122 are moved away from the magnetic sensor 121.

In the same way, as the shifter lever 110 is driven by the user to the left, that is counter clockwise movement defined by arrow B, in the second plane YZ for selecting a manual or an automatic mode of operation, spring 176 pushes the driving plate 170 also counter clockwise such that the support member 123 together with the magnet 122 are moved towards the magnetic sensor 121.

In both cases, longitudinal displacement of the support member 123 together with the magnet 122 relative to the magnetic sensor 121 is detected by the sensing unit 120 and a suitable signal is sent to a control unit that the shifter lever 110 is being actuated for selecting one mode of operation.

The width of the driving plate 170 is sized so as to accommodate rotation of the shifter lever 110, that is, to ensure that the actuator 115 of the shifter lever 110 is always capable of pushing the driving plate 170 on the lower end thereof regardless the position of the shifter lever 110 as it is rotated according to arrow A in plane XZ.

In the example shown in FIGS. 1-2 of the drawings, a driving member 140 is provided. The driving member 140 includes a cylindrical sector of a given extension that is in frictional contact with the outer surface of the support member 123. Other types of couplings, as gears or cams, between the driving member 140 and the support member 123 are possible. FIGS. 1-2 of the drawings show, by way of one example, two driving members 140 includes cylindrical sectors of different extensions. In any case, the driving member 140 is attached to or is part of the shift shaft 150 and is arranged to contact the support member 123. In this way, as the shifter lever 110 is actuated by the user in a forward-to-backward movement in the first plane XZ for changing gearshift positions, the rotational movement of the shift shaft 150 according to arrow A causes a corresponding movement of the support member 123 and thus the magnet 122 around axis Y. The driving member 140 is sized according to the distance between the shift shaft 150 and the support member 123 and such that a rotation angle of the support member 123 is 2-5 times higher than a rotation angle of the shift shaft 150 and thus that of the shifter lever 110. Other ratios of the rotation angle are of course not ruled out. In this case, a rotational displacement of the magnet 122 between two consecutive gearshift positions may be from 7 to 14°.

As with the driving plate 170, the driving member 140 thus acts as a multiplier causing the amount of rotational movement of the shifter lever 110 to be different to that of the support member 123 as the shifter lever 110 is actuated in a forward-to-backward movement according to arrow A.

In the example shown in FIGS. 3 and 4 of the drawings, no driving member 140 is provided. In this case, a rotation angle of the support member 123 is equal to a rotation angle of the shift shaft 150.

A printed circuit board 130 is provided. The printed circuit board 130 is positioned in a substantially vertical position as shown in the figures. A substantially vertical position is defined to correspond to herein as a position in which the printed circuit board 130 is arranged substantially perpendicular to the support member 123. In the specific example shown, the printed circuit board 130 is also arranged substantially perpendicular to the shift shaft 150.

The magnetic sensor 121 is connected to the printed circuit board 130 such that the above mentioned rotational and axial displacement movements of the magnet 122 relative to the magnetic sensor 121 can be detected. As a result, corresponding suitable electrical signals which are fed to a control unit in order to control a vehicle transmission.

The above described structure allows two different movements of the shifter lever 110, that is, movements in first and the second planes ZX, YZ to be detected by the same magnetic sensor 121 and the same magnet 122. A simple, reliable and cost-effective shifter assembly 100 is obtained.

A number of particular embodiments and examples of the present shifter assembly have been disclosed herein. It will be however understood by those skilled in the art that other alternative examples and/or uses and obvious modifications and equivalents thereof are possible. For example, a driving member has been described and illustrated consisting of a cylindrical sector that is attached to or is part of the shift shaft for driving the support member by frictional contact but other types of means for driving the support member may be used such as gears and the like. On the other hand, although the use of magnetic sensors has been described, other types of sensors can be used such as for example a combination of hall sensors, inductive sensors, optical sensors or even mechanical switches. The present disclosure thus covers all possible combinations of the particular examples described.

Although examples have been described where the shifter lever 110 can be moved substantially in a first plane XZ and substantially in a second, different plane YZ, the movements of the shifter lever 110 could be performed in many other planes, that is, the first and or second movements of the shifter lever 110 could be performed substantially in more than the first and second planes.

The scope of the present disclosure should not be limited by particular examples, but should be determined only by a fair reading of the claims that follow.

Reference signs related to drawings and placed in parentheses in a claim, are solely for attempting to increase the intelligibility of the claim and shall not be construed as limiting the scope of the claim.

What is claimed is:

1. A shifter assembly for controlling a vehicle transmission, the assembly comprising:
a shifter lever that is pivotally mounted to a fixed base such that it can be moved according to a first movement and according to a second, different movement, and
a single sensing unit arranged to detect both rotational and axial displacement movements of a magnet so as to identify whether the first or second movement is being performed by the shifter lever.

2. The shifter assembly of claim 1, wherein the rotational movement of the magnet is caused by the first movement of the shifter lever.

3. The shifter assembly of claim 1, wherein the rotational movement of the magnet is caused by a corresponding rotational movement of the shifter lever such that a rotation angle of the magnet is higher than a rotation angle of the shifter lever.

4. The shifter assembly claim 1, further comprising a driving member to drive the magnet in rotation as the shifter lever is actuated according to the first movement.

5. The shifter assembly of claim 4, wherein the driving member is attached or is part of a shift rod arranged to be driven in rotation as the shifter lever is actuated according to the first movement.

6. The shifter assembly of claim 5, wherein a ratio of a rotation angle of the magnet and a rotation angle of the shifter lever ranges from 2 to 5°, and wherein a rotational displacement of the magnet between the gearshift positions ranges from 7 to 14°.

7. The shifter assembly of claim 1, further comprising a magnetic sensor that is arranged on a printed circuit board operative to detect both the rotational and axial displacement movements of the magnet and to generate corresponding electrical signals to control a vehicle transmission.

8. The shifter assembly of claim 7, wherein the printed circuit board is positioned substantially in a vertical position.

9. The shifter assembly of claim 7, wherein the magnet is provided at one end portion of a support member and facing the magnetic sensor.

10. The shifter assembly of claim 9, wherein a surface of the magnet facing the magnetic sensor has at least a first pole and a second pole.

11. The shifter assembly of claim 1, wherein the first movement of the shifter lever is performed substantially in a first plane (XZ) and the second movement of the shifter lever is performed substantially in a second, different plane (YZ).

12. The shifter assembly of claim 1, wherein the single sensing unit includes a single magnetic sensor that is adapted to detect both rotational and axial displacement movements of the magnet, so as to identify whether the first or second movement is being performed by the shifter lever.

13. The shifter assembly of claim 1, further comprising a driving plate for causing an axial displacement of the magnet as the shifter lever is actuated.

14. The shifter assembly of claim 1, wherein the magnet is arranged to perform a rotational movement relative to a magnetic sensor of the single sensing unit according to one of the first or second movements of the shifter lever, and also to perform an axial displacement movement relative to the magnetic sensor according to the other of the first or second movements of the shifter lever.

15. The shifter assembly of claim 1, wherein one of the first and second movements is to perform shift operations involving changing gearshift positions for controlling a vehicle transmission in at least one mode of operation, and the other of the first and second movements is to perform select operations to change between at least two different modes of operation.

16. A shifter assembly for controlling a vehicle transmission, the assembly comprising:
a shifter lever pivotally mounted to a fixed base to move according to a first movement and according to a second movement, the first movement being different that the second movement; and
a single sensing unit arranged to detect a rotational movement and an axial displacement of a magnet so as to identify whether the first movement or the second movement is being performed by the shifter lever.

17. The shifter assembly of claim 16, wherein the first movement of the shifter lever causes the rotational movement of the magnet.

18. The shifter assembly of claim 16, wherein a corresponding rotational movement of the shifter causes the rotational movement such that a rotation angle of the magnet is higher than a rotation angle of the shifter lever.

19. The shifter assembly claim 16, further comprising a driving member to drive the magnet in rotation as the shifter lever is actuated according to the first movement.

20. A shifter assembly for controlling a vehicle transmission, the assembly comprising:
a shifter lever mounted to a fixed base such that the shift lever can be moved according to a first movement and according to a second movement, the first movement being different than the second movement, and
a single sensing unit arranged to detect both a rotational movement and an axial displacement movement of a magnet to identify whether the first movement or the second movement is being performed by the shifter lever.
